(19) United States
(12) Patent Application Publication
(10) Pub. No.: US 2005/0210166 A1
(43) Pub. Date: Sep. 22, 2005

(54) Dual function busy pin

(76) Inventors: Raymond Chow, Richmond (CA); Jimmy Kwok Lap Lai, Vancouver (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/802,978

(22) Filed: Mar. 17, 2004

(51) Int. Cl. G06F 3/00

(52) U.S. Cl. 710/51

(57) ABSTRACT

Provided is a method and apparatus for multiplexing a busy signal and another signal via a dual function pin. Specifically, a multiplexer in a display controller can select a wait signal or the busy signal and generate a signal to a processor. The signal to the processor can indicate the availability of a module in the display controller, such as JPEG module, for access by the processor. If the module is not available for access, then the processor continuously processes tasks without attempting to access the module in the display controller. The dual function pin, by interfacing with the busy signal, obviates an attempt by the processor to determine the availability of the module and permits backward compatibility with processors that can interface with another signal.

### BACKGROUND OF THE INVENTION

1. Field of the Invention

The present invention relates to processors, and more specifically to communication between processors in embedded systems.

2. Description of the Related Art

Typically, processors in embedded systems have specialized functions. For example, a general-purpose processor (GPP) can interface with a graphics processor to provide graphics functionality to a liquid crystal display (LCD). To enable these functions, various connections permit communication of data and addresses between the GPP and the graphics processor. The various connections are typically enabled with pins on the processors connected via circuit connectors in a circuit board. For a GPP using direct addressing, an appropriate number of pins can communicate the data and addresses to the graphics processor simultaneously in one bus clock. Alternatively, for a GPP using indirect addressing, the data and addresses can be communicated to the graphics processor in separate bus clocks by using fewer pins than the number of pins used in direct addressing.

In one current implementation, the GPP can connect to a WAIT# pin on the graphics processor. The WAIT# pin permits the graphics processor to request that the GPP slow down processing by actively driving the WAIT# pin to a logical state during a processing cycle on the GPP. When the GPP detects the signal from the graphics processor, the GPP waits and extends the current processing cycle until the graphics processor stops the signal or drives the pin in reverse logical state.

Supporting the function of the WAIT# pin may have the undesirable effect of holding the GPP in a wait state, thus preventing the GPP from processing other tasks and reducing the overall performance of the embedded system. In real-time embedded applications or systems where the GPP is already heavily burdened, the WAIT# pin is typically not supported to prevent holding the GPP in a wait state.

A disadvantage of not supporting the WAIT# pin is that read and write requests between the GPP and the graphics processor can require a fixed amount of processing cycles to initiate the request. For example, if the GPP requests read access to a memory module in the graphics processor, then the processing cycle must be fixed to the longest amount of processing cycles required to communicate the request to any module in the graphics processor. Thus, if the shortest processing cycle is 2 bus clocks and the longest processing cycle is 15 bus clocks, then any request from the GPP to the graphics processor is set to 15 bus clocks, thereby wasting processing cycles for requests that require less than 15 bus clocks.

For a GPP using indirect addressing, the WAIT# pin is typically not supported. Instead, current implementations require polling of a register on the graphics processor to determine if a module in the graphics processor is available. If the module is busy, then the GPP must continuously poll the register to determine if the module is available. Unfortunately, polling degrades overall performance of the embedded system because of increased bus traffic on the connector between the GPP and the graphics processor. Further, considerable power is consumed when the GPP polls the register, thus reducing performance.

Accordingly, what is needed is a method and apparatus for reducing wasted processing cycles in an embedded system, thus increasing the overall efficiency of the embedded system.

### SUMMARY OF THE INVENTION

Broadly speaking, the present invention is a method and apparatus for reducing wasted processing cycles in an embedded system by the use of a dual function pin. It should be appreciated that the present invention can be implemented in numerous ways, such as a process, an apparatus, a system, a device or a method. Several inventive embodiments of the present invention are described below.

In one embodiment, a method for increasing the processing capability of a device can include requesting access to a module in a display controller and processing continuously until notification by the module in the display controller, such that a multiplexer in the display controller sends a first signal to a pin when the module is available. Further, the method can include accessing the module in the display controller after receiving the first signal via the pin.

In another embodiment, another method can include transmitting a first signal from a first processor to a second processor and routing the first signal to a module in the second processor, such that the first signal indicates to the module that the first processor requires one of read or write access to the module. The method also includes selecting a second signal from one of a wait signal or a busy signal in a multiplexer on the second processor. Finally, the method can include processing continuously in the first processor until the receipt of the busy signal via a pin.

An exemplary embodiment for a device can include a first processor coupled to a pin, such that the first processor is capable of continuously processing after transmitting a signal requesting access to a module in a second processor. The embodiment can also include a multiplexer in the second processor coupled to the pin, such that the pin is capable of notifying the first processor of the availability of the module in the second processor by the selection of one of a wait signal or a busy signal in the multiplexer.

In yet another embodiment, a controller configured to receive a first signal can include a plurality of first modules internal to the controller, such that the plurality of first modules is capable of accessing a plurality of second modules external to the controller. Further, a multiplexer can be coupled to the plurality of first modules via a combinatorial multiplexer, such that the multiplexer is capable of transmitting a second signal to a pin by selecting one of a wait signal or a busy signal in the multiplexer in response to the first signal. A connector can also be coupled to the multiplexer and the pin, such that the connector is capable of transmitting the second signal to a source of the first signal.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is a diagram illustrating multiple devices using embedded systems, in accordance with an embodiment of the invention;

FIG. 2 is a diagram illustrating a mobile device, in accordance with an embodiment of the invention;

FIG. 3A is a diagram illustrating a display controller, in accordance with an embodiment of the invention;

FIG. 3B is a diagram illustrating another display controller, in accordance with an embodiment of the invention;

FIG. 4 is a diagram illustrating registers in a display controller, in accordance with an embodiment of the invention;

FIG. 5 illustrates a timing diagram, in accordance with an embodiment of the invention; and

FIG. 6 is a diagram of a method for activating a dual function pin, in accordance with an embodiment of the invention.

### DETAILED DESCRIPTION OF THE PREFERRED EMBODIMENTS

The following embodiments describe a method and apparatus for reducing wasted processing cycles in an embedded system by using a dual function pin. In one embodiment, a busy signal is propagated over a pin, such as a WAIT# pin. In another embodiment, the busy signal can be propagated over an unused pin. However, the pin used to propagate the busy signal is irrelevant as long as wasted processing cycles are reduced. It will be obvious, however, to one skilled in the art, that the present invention may be practiced without some or all of these specific details. In other instances, well known process operations have not been described in detail in order not to unnecessarily obscure the present invention.

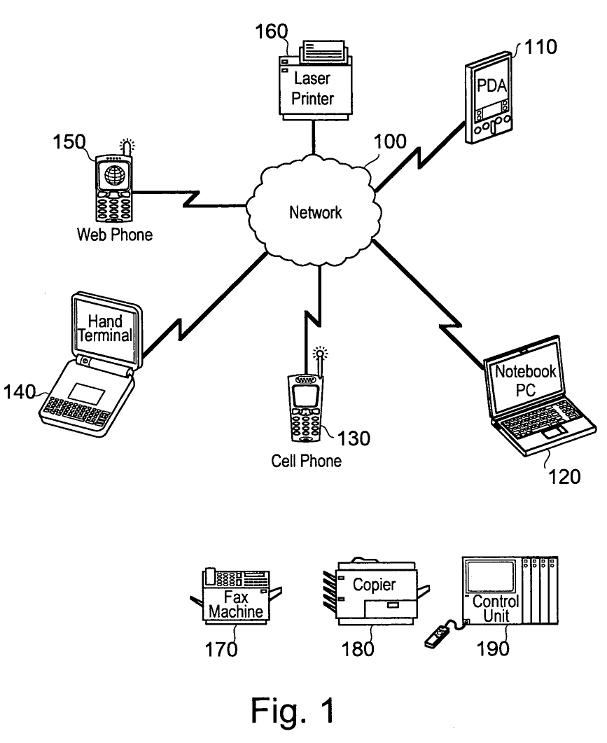

FIG. 1 is a diagram illustrating multiple devices using embedded systems, in accordance with an embodiment of the invention. Exemplary devices using embedded systems can be a personal digital assistant (PDA) 110, a notebook personal computer (PC) 120, a cell phone 130, a hand terminal 140, a web phone 150, and a laser printer 160. All the devices can communicate with one another via a network 100. Alternatively, other devices such as a fax machine 170, a copier 180, and a control unit 190 can stand alone and not communicate via the network 100. In other exemplary embodiments, any suitable device may be used with the embodiments described herein whether functioning as a stand alone or using the network 100 to communicate with other devices, as long as the embedded system uses a dual function pin to reduce wasted processing cycles.

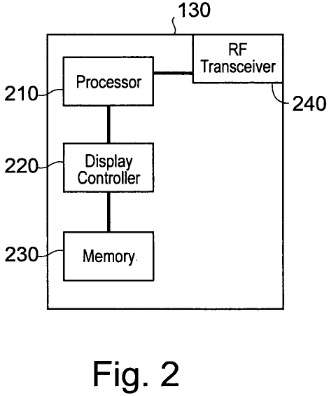

FIG. 2 is a diagram illustrating a mobile device, in accordance with an embodiment of the invention. An exemplary mobile device with an embedded system capable of communicating with other devices is the cell phone 130. The cell phone includes a processor 210 coupled to a display controller 220 and a radio frequency (RF) transceiver 240. Further, the display controller 220 is coupled to a memory 230. In an exemplary cell phone 130, the RF transceiver 240 continuously receives RF signals that are processed by the processor 210. If the processor 210 requires access to the memory 230, then the processor 210 can request access via the display controller 220. Because the processor 210 continuously processes RF signals from the RF transceiver 240, the processor 210 wastes processing cycle and decreases overall performance by waiting fixed bus cycles or polling a register in the display controller 220 when requesting access to the memory 230 via the display controller 220. In one embodiment, by using a dual function pin in the display controller 230, the processor 210 can continue to process RF signals along with other tasks after initiating access to the display controller 220.

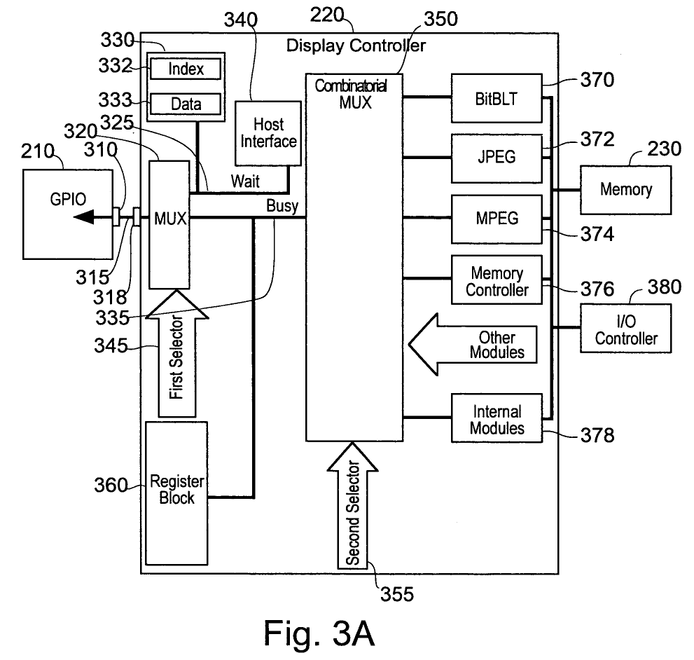

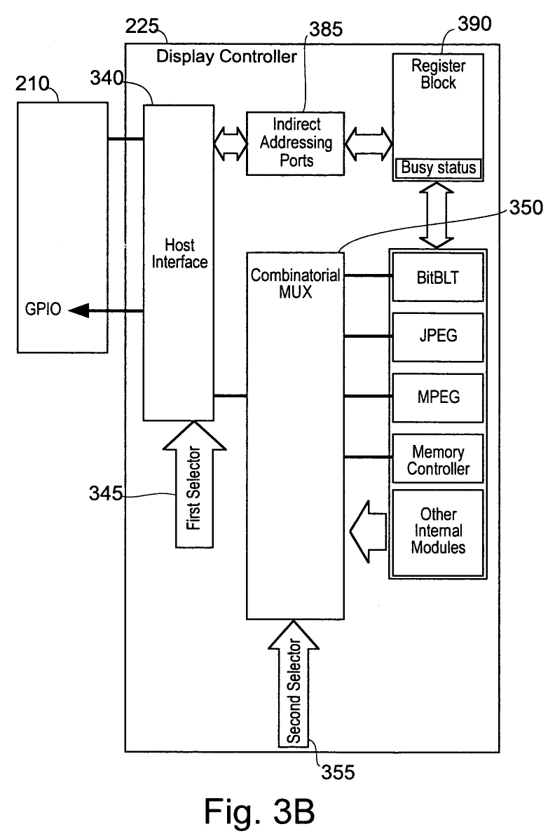

Correspondingly, FIG. 3A is a diagram illustrating the display controller 220, in accordance with an embodiment of the invention. For example, the processor 210 can connect to the display controller 220 via a connector 315. A general purpose I/O (GPIO) pin 310 on the processor 210 can communicate via the connector 315 to a dual function busy pin (pin) 318 on the display controller 220. The pin 318 can be implemented by dedicating or multiplexing a busy signal on an external pin. Further, a configuration register (not shown) or a configuration register bit (not shown) can enable the pin 318. However, any method of enabling the pin 318 is possible, as long as the function of a BUSY# pin is enabled. In other embodiments, the pin 318 can connect to any pin on the processor 210 as long as the pin on the processor 210 is configured to communicate with the pin 318.

The pin 318 coupled to a multiplexer 320 is capable of receiving a wait signal via a wait signal connector 225 and a busy signal via a busy signal connector 335. Although the multiplexer 320 is shown receiving two different signals via two connectors, the illustration is exemplary. In other embodiments, the multiplexer 320 can multiplex any number of connectors. Moreover, in yet another embodiment, the busy signal can be propagated to the processor 210 without the multiplexer 320 as long as wasted processing cycles are reduced.

Further, a first selector 345 coupled to the multiplexer 320 is capable of selecting the wait signal or the busy signal. When the first selector 345 selects the busy signal, the multiplexer 320 propagates a signal via the pin 318. The signal can indicate a logic state or can be a pulse, such as an edge-triggered signal. Upon receiving the signal from the pin 318, the processor 210 checks the pin 318 in response to the signal and halts processing to access the display controller 220. Alternatively, the multiplexer 320 can drive a logic state via the pin 318 to indicate to the processor 210 the availability of the display controller 220.

The display controller 220 has a first register block 330 including a plurality of registers such as an index register 332 and a data register 333. The first register block 330 is capable of providing indirect addressing to the processor 210. Further, a host interface 340 arbitrates communication with the processor 210.

Coupled to the busy signal connector 335 is a second register block 360 and a combinatorial multiplexer 350, the latter containing combinatorial and multiplexing logic. Further coupled to the combinatorial multiplexer 350 are multiple modules. Exemplary modules can include a BitBLT module 370, a JPEG module 372, an MPEG module 374, a memory controller module 376, and other internal modules 378. The BitBLT module 370 can perform bit block transfers of color data in graphics applications and the JPEG module 372 and the MPEG module 374 can perform compression functions for still and moving images, respectively. Moreover, the memory controller module 376 is capable of coordinating access to the memory 230 (FIG. 2). In other embodiments, any number of internal modules 378 are possible for performing the functions of the display controller 220, as long as the display controller 220 uses a dual function pin.

Accordingly, the combinatorial multiplexer 350 can use a second selector 355 to select signals from among the multiple modules and route the signals to the multiplexer 320. Then, information regarding the busy status of the multiple modules can be stored in the second register block 360. Alternatively, information regarding the busy status of any one of the multiple modules can bypass the second register block 360 and can propagate directly to the multiplexer 320. In yet another embodiment, for backward compatibility, a plurality of busy status bits (not shown) in the second register block 360 can permit busy pin toggling. The busy status bits can also be configured with a configuration register (not shown) permitting the enabling or the disabling of busy pin toggling. For example, busy pin toggling may be disabled during extended periods of no activity from the processor 210 to the display controller 220, thus saving power.

The multiple modules internal to the display controller 220 can be a first plurality of modules that are coupled to a second plurality of modules external to the display controller 220. Specifically, the memory 230 and an I/O controller 380 can be modules external to the display controller 220. Thus, when the processor 210 requests read or write access to the memory 230, the processor 210 can send a signal to the display controller 220 indicating the request for access. Then, while the processor 210 continues processing information such as RF signals from the RF transceiver 240, the display controller 220 determines the availability of the memory controller module 376 to access the memory 230.

If the memory controller module 376 is not available, then the processor 210 can continuously process information such as RF signals. When the memory controller 376 is available, the combinatorial multiplexer 350 selects the signal from the memory controller module 376 via the second selector 355 and sends the signal to the busy signal connector 335. Then, the multiplexer 320 can select from either the wait signal or the busy signal via the first selector 345. Consequently, the multiplexer 320 can use the pin 318 to send a signal to the GPIO pin 310 on the processor 210 indicating the availability of the memory controller module 376 for read or write access. The processor 210 can then halt processing of information, such as the continuous processing of RF signals, to access the memory 230.

In other exemplary embodiments, the processor 210 need not halt processing RF signals. Instead the processor 210 can halt processing of other processes that may be related to the read or write access to the memory 230. Further, although the example refers to accessing the memory controller module 376, any of the modules internal to the display controller 220 can function using the same methodology, as long as the display controller 220 uses a dual function pin.

FIG. 3B is a diagram illustrating another display controller, in accordance with an embodiment of the invention. In one embodiment, the processor 210 can access a display controller 225 via indirect addressing. During the design stage, the busy signal can be connected to the WAIT# pin or another available pin. Thereafter, during operation, when the processor 210 requests access to the display controller 225, the modules in the display controller 225 can indicate a “busy” status to the processor 210. While the modules are “busy,” the processor 210 continuously processes other tasks until the modules in the display controller 225 indicate a not “busy” status. When “busy,” the display controller 225 can use a register block 390 to indicate the “busy” status of a module. Consequently, the processor 210 can access data and addresses in the register block 390 via indirect addressing ports 385 when the display controller 225 is no longer “busy.”

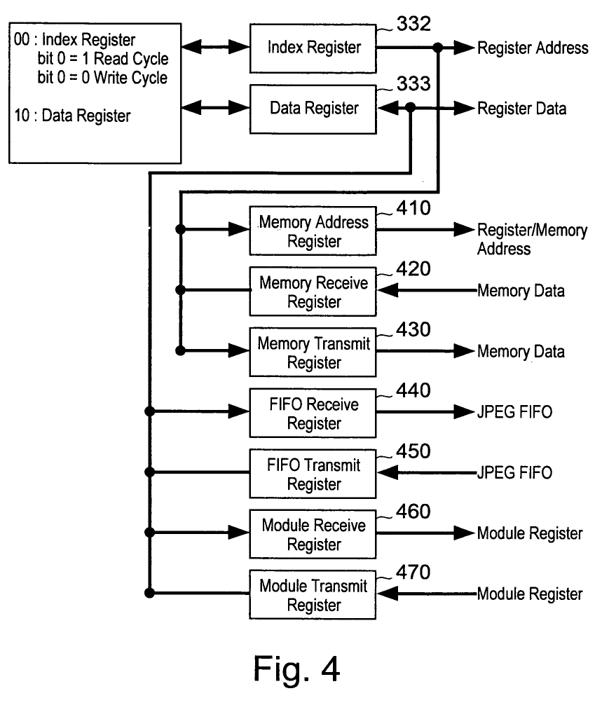

FIG. 4 is a diagram illustrating registers in the display controller 220, in accordance with an embodiment of the invention. Specifically, the index register 332 and the data register 333 can be coupled to a memory address register 410, a memory receive register 420, a memory transmit register 430, a first in first out (FIFO) receive register 440, a FIFO transmit register 450, a module receive register 460, and a module transmit register 470. In one exemplary embodiment using indirect addressing, an address can be stored in the index register 332 and data can be stored in the data register 333. Subsequently, the data in the data register 333 can be stored in a register such as the FIFO transmit register 450. However, regardless of the addressing method the processor 210 uses to communicate to the display controller, the display controller 220 can reduce wasted processing cycles in the processor 210 by using a dual function pin.

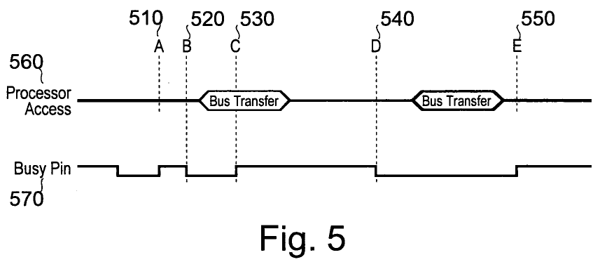

FIG. 5 illustrates a timing diagram, in accordance with an embodiment of the invention. The timing diagram shows exemplary timing relationships between a processor access line 560 and a busy pin line 570. In one exemplary embodiment, at a time-A 510 on the processor access line 560, the processor 210 continuously processes until the processor 210 requires access to the display controller 220. At time-B 520, the busy pin line 570 indicates that is it not “busy” and that the processor 210 can access the display controller 220. During the bus transfer, the display controller 220 indicates that it is once again “busy” and the processor 210 can gracefully stop the bus transfer at time-C 530. Consequently, while the busy pin line 570 indicates that the display controller 220 is “busy,” the processor 210 can transition to continuously process other tasks after gracefully stopping the bus transfer. At time-D 540, the busy pin line 570 indicates that the display controller 220 is not “busy” and the processor 210 resumes the bus transfer. After time-E 550, the processor 220 completes accessing the display controller 220.

Although the busy pin line 570 illustrates a “busy” display controller 220 with a logical high value, alternative embodiments can indicate “busy” with a logical low value. Further, in other embodiments, pulses can also represent the high and low logic states illustrated by the busy pin line 570. In yet another embodiment, when the processor 210 communicates via indirect addressing, a single input line (not shown) can indicate whether an address is stored in the index register 332 or the data register 333. The timing relationships illustrated in the timing diagram are exemplary and in other embodiments, other timing relationships with other lines are possible, as long as the processor 210 and the display controller 220 communicate the availability of a module in the display controller 220 with a dual function pin.

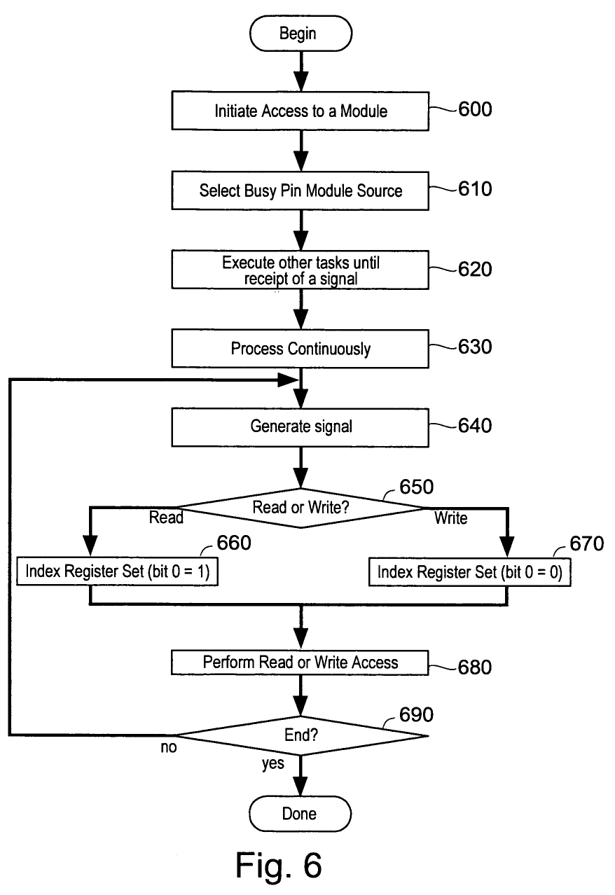

FIG. 6 is a diagram of a method for activating a dual function pin, in accordance with an embodiment of the invention. The method can begin in operation 600 when the processor 210 initiates access to a module, such as the JPEG module 372, in the display controller 220. Consequently, in operation 610, the display controller 220 selects the busy signal to determine the availability of the JPEG module 372. While the display controller 220 checks the availability of the module, the processor 210 executes other tasks until the receipt of a signal from the dual function pin in operation 620. Specifically, in operation 630, the processor 210 processes continuously until notification of the availability of the module.

After the module sends a signal to the pin 318 coupled to the multiplexer 320, the multiplexer 320 selects the busy signal and in operation 640, generates a signal to the processor 210 indicating the availability of the module. Thus, in operation 650, if the processor 210 requires read access, then in operation 660, the index register 332 can be set to receive an address for read access. In one embodiment, a bit in the index register 332 can be set to a logical high value to indicate read access. Alternatively, for a write access, in operation 670, the bit in the index register 332 can set to a logical low value to indicate a write to a particular address. Of course, the logical high value and the logical low value are purely exemplary. For example, a logical low value can indicate read access and a logical high value can indicate write access. Subsequently, in operation 680, the processor 210 performs the read or write access. Then, in operation 690, the method ends if the read or write access is complete. Otherwise, the method returns to operation 640 and repeats as described above.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

1. A method for increasing the processing capability of a device, comprising:
requesting access to a module in a display controller;
processing continuously until notification by the module in the display controller, wherein a multiplexer in the display controller sends a first signal to a pin when the module is available; and
accessing the module in the display controller after receiving the first signal via the pin.

2. A method for increasing the processing capability of a device of claim 1, wherein requesting access to a module in a display controller includes transmitting a second signal to the module in the display controller.

3. A method for increasing the processing capability of a device of claim 1, wherein processing continuously until notification by the module in the display controller includes checking the pin in response to the first signal.

4. A method for increasing the processing capability of a device of claim 1, wherein processing continuously until notification by the module in the display controller includes selecting a wait signal or a busy signal from the multiplexer to transmit the first signal.

5. A method for increasing the processing capability of a device of claim 4, wherein selecting one of the wait signal and the busy signal from the multiplexer includes halting processing.

6. A method for increasing the processing capability of a device of claim 1, wherein requesting access to a module in a display controller further includes providing indirect addressing for communication.

7. A method, comprising:
transmitting a first signal from a first processor to a second processor;
routing the first signal to a module in the second processor, wherein the first signal indicates to the module that the first processor requires one of read and write access to the module;
selecting a second signal from one of a wait signal and a busy signal in a multiplexer on the second processor; and
processing continuously in the first processor until the receipt of the busy signal via a pin.

8. A method of claim 7, wherein selecting the second signal from one of the wait signal and the busy signal in the multiplexer on the second processor includes transmitting the busy signal to indicate to the first processor that the module is available for one of read and write access.

9. A method of claim 7, wherein processing continuously in the first processor until the receipt of the busy signal via the pin includes halting processing on the first processor.

10. A method of claim 7, wherein processing continuously in the first processor until the receipt of the busy signal via the pin includes receiving the signal.

11. A device, comprising:
a first processor coupled to a pin, the first processor being capable of continuously processing after transmitting a signal requesting access to a module in a second processor; and
a multiplexer in the second processor coupled to the pin, the pin being capable of notifying the first processor of the availability of the module in the second processor by the selection of one of a wait signal and a busy signal in the multiplexer.

12. A device of claim 11, wherein the second processor includes a combinatorial multiplexer coupled to the multiplexer, the combinatorial multiplexer being capable of routing signals from the module to the multiplexer.

13. A device of claim 12, wherein the module connects to the combinatorial multiplexer and an external module, the external module being external to the second processor.

14. A device of claim 11, wherein the pin is coupled to a plurality of registers in the second processor, the plurality of registers being capable of providing indirect addressing to the first processor.

15. A device of claim 11, wherein a signal propagates via a connection to the pin indicating the availability of the module, the signal being capable of halting processing on the first processor.

16. A device of claim 11, wherein the module is selected from the group consisting of a BitBLT module, a JPEG module, and an MPEG module.

17. A device of claim 11, wherein the first processor and the second processor communicate via indirect addressing.

18. A display controller configured to receive a first signal, comprising:
a plurality of first modules internal to the controller, the plurality of first modules being capable of accessing a plurality of second modules external to the controller;
a multiplexer coupled to the plurality of first modules via a combinatorial multiplexer, the multiplexer being capable of transmitting a second signal to a pin by selecting one of a wait signal and a busy signal in the multiplexer in response to the first signal; and
a connector coupled to the multiplexer and the pin, the connector being capable of transmitting the second signal to a source of the first signal.

19. A display controller configured to receive a first signal of claim 18, wherein the busy signal propagates via the connector.

20. A display controller configured to receive a first signal of claim 18, wherein the first signal is a transmission requesting one of read and write access to the plurality of first modules.

21. A display controller configured to receive a first signal of claim 18, wherein the second signal is a transmission from the plurality of first modules to the pin indicating the availability of the plurality of first modules for one of read and write access.

22. A display controller configured to receive a first signal of claim 18, wherein a first selector is capable of selecting one of a wait signal and a busy signal in the multiplexer.

23. A display controller configured to receive a first signal of claim 18, wherein a second selector in the combinatorial multiplexer is capable of selecting a module from the plurality of first modules.

24. A display controller configured to receive a first signal of claim 18, wherein the source of the first signal is a processor continuously processing.

25. A display controller configured to receive a first signal of claim 18, wherein the source communicates via indirect addressing.
